(19) United States
(12) Patent Application Publication
(10) Pub. No.: US 2015/0308189 A1
(43) Pub. Date: Oct. 29, 2015

(54) Ladder Rung Plug

(71) Applicant: CVC Construction, LLC, Denver, CO (US)

(72) Inventor: Carlos F. Valdez-Carrazco, Denver, CO (US)

(21) Appl. No.: 14/267,448

(22) Filed: May 1, 2014

Related U.S. Application Data
(60) Provisional application No. 61/818,236, filed on May 1, 2013.

(51) Int. Cl. E06C 7/00

(52) U.S. Cl. CPC E06C 7/00

(57) ABSTRACT

A ladder rung plug for reduction of noise caused by an interaction of air with ladder rung openings is provided. The ladder rung plug includes an insert portion and a cap portion. The insert portion of the ladder rung plug is configured to fit into a ladder rung opening, while the cap portion is configured to remain outside the ladder rung opening. Once placed, the ladder rung plug may not fall out or become accidentally dislodged; however, the ladder rung plug is readily removable by using a claw hammer or similar instrument.

### CROSS-REFERENCE TO RELATED APPLICATIONS

The present application claims benefit of priority to U.S. Provisional Patent Application No. 61/818,236, entitled “Ladder Rung Plug” and filed on 1 May 2013, specifically incorporated by reference herein for all that it discloses or teaches.

### BACKGROUND

Ladder rungs frequently have openings at the ends of the rungs. The openings provide access to hollow rung interiors. When ladders with open rung ends are carried on a vehicle or otherwise exposed to wind, the wind produces a noise as it interacts with the rung opening. The produced noise can be referred to as whistling or howling. The noise may become louder and may change pitch with increasing vehicle or wind speed. Multiple ladders may be louder than a single ladder. The noise can be distracting or annoying, particularly with multiple ladders carried on a motor vehicle at highway speed.

### SUMMARY

Implementations described and claimed herein address the foregoing problems by providing a ladder rung plug for ladder rung openings. The ladder rung plug would insert securely in rung end openings, but also be readily removable.

### BRIEF DESCRIPTIONS OF THE DRAWINGS

FIG. 1 illustrates a perspective view of an example ladder rung plug.

FIG. 2 illustrates another perspective view of an example ladder rung plug.

FIG. 3 illustrates an example ladder rung plug installed in a ladder rung opening

FIG. 4 illustrates another example ladder rung plug installed in a ladder rung opening.

FIG. 5 illustrates an example method of removal of a ladder rung plug from a ladder rung opening.

FIG. 6 illustrates another example method of removal of a ladder rung plug from a ladder rung opening.

FIG. 7 illustrates another example method of removal of a ladder rung plug from a ladder rung opening.

FIG. 8 illustrates use of multiple ladder rung plugs in a ladder.

FIG. 9 illustrates a perspective view of another example ladder rung plug.

FIG. 10 illustrates example operations for installing, using, and removing a ladder rung plug.

### DETAILED DESCRIPTIONS

Embodiments of the present invention include a ladder rung plug for insertion into a ladder rung opening in order to reduce noise generated by air rushing across the opening. The ladder rung plugs may comprise a cap portion and an insert portion. The cap portion may be too large to fit into the rung opening, whereas the insert portion is configured to fit into such opening. In some embodiments, the insert portion is cylindrical, or forms a partial cylinder. The partially-cylindrical insert portion may be adapted to be slightly collapsible by pushing the partial cylinder walls together. This collapsibility allows for insertion into a rung opening. The insert portion may be resilient such that upon insertion into a ladder rung, the insert portion rebounds and approaches its pre-collapsed state in order to achieve a friction fit in the ladder rung.

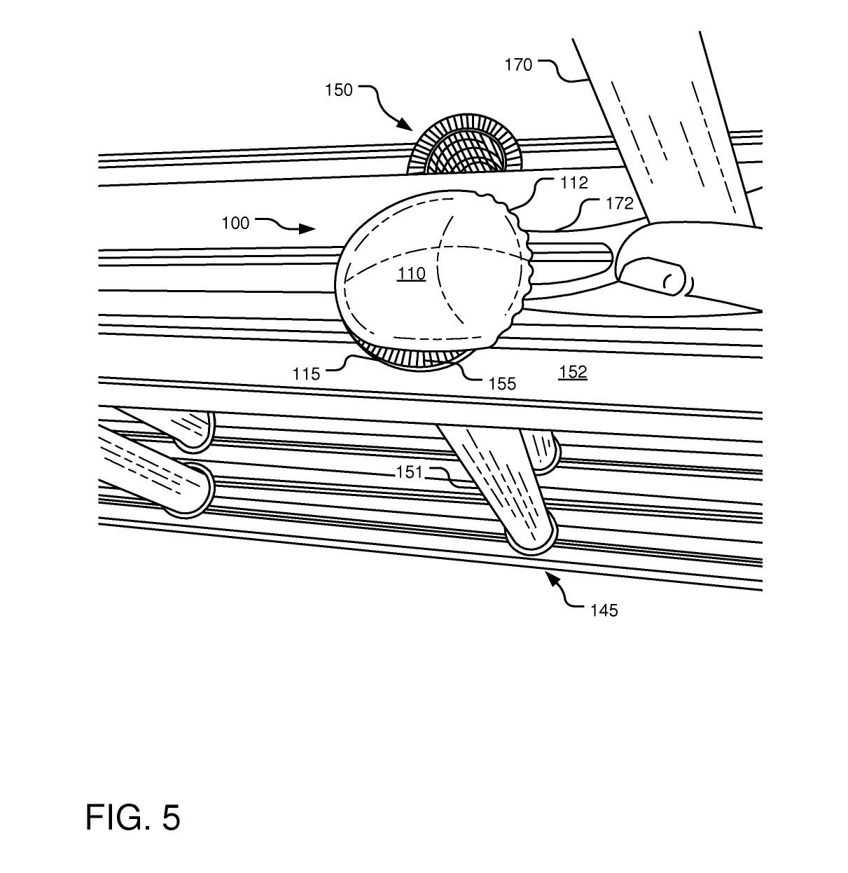

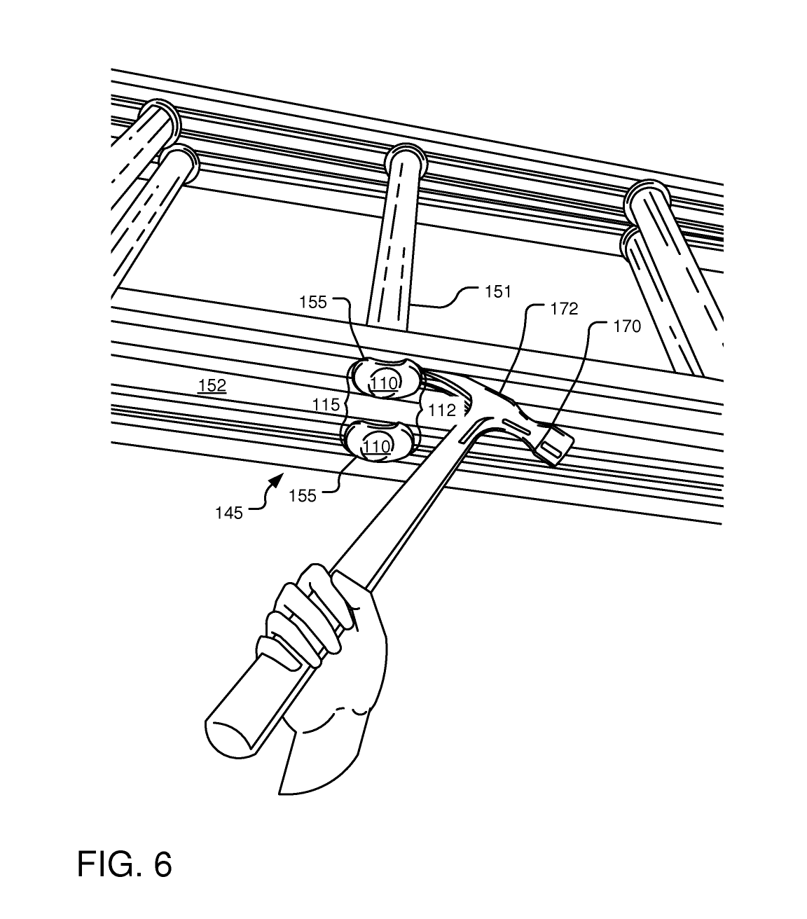

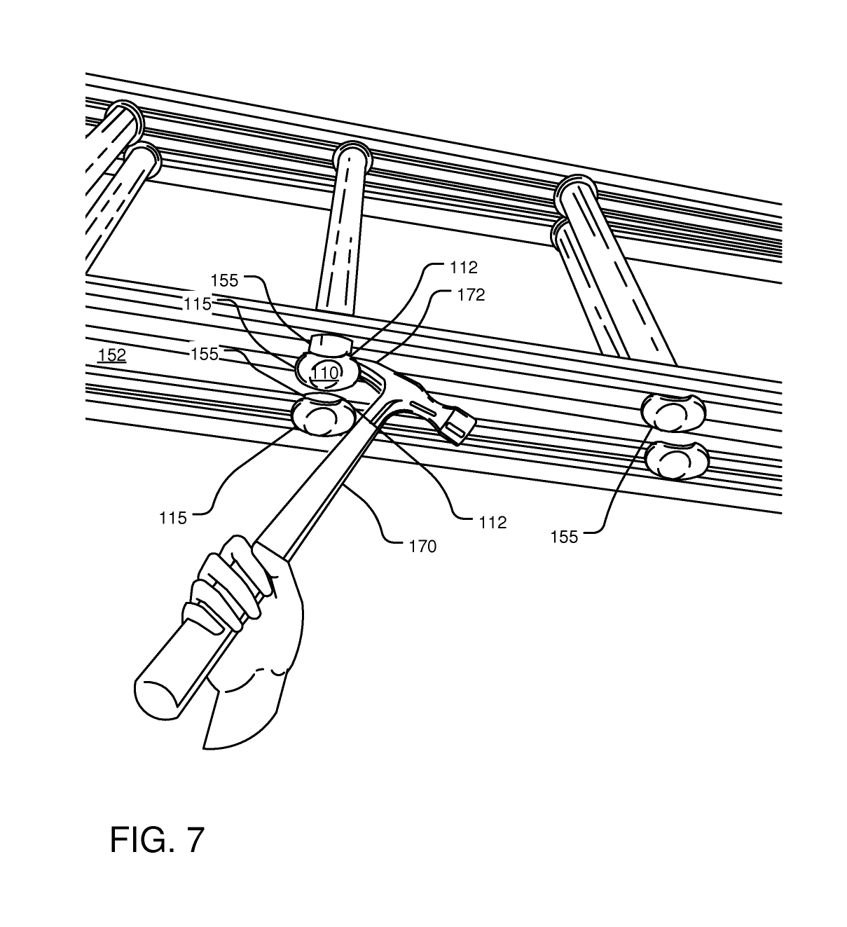

The friction fit is generally tight, preventing the plug from falling out of or becoming accidentally dislodged from within the rung. Despite a tight and secure fit in a ladder rung, the ladder rung plugs may be readily removable. Facile removal of the ladder rung plug may be achieved by inserting a claw of a claw hammer between a ladder rail and a tab portion of the plug cap, and prying the plug from within the ladder rung (see FIG. 5, FIG. 6, and FIG. 7). When installed in most or all of the rung openings of a ladder, the plugs may reduce wind noise generated by the ladder as it is transported on a motor vehicle, particularly at highway speed.

The terms and phrases as indicated in quotation marks (“ ”) in this section are intended to have the meaning ascribed to them in this section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given. The term “about,” as used in this specification and appended claims, refers to plus or minus 20% of the value given.

The terms “generally” and “substantially,” as used in this specification and appended claims, mean mostly, or for the most part.

The terms “removable”, “removably coupled”, “removably installed,” “readily removable”, “readily detachable”, “detachably coupled”, “separable,” “separably coupled,” and similar terms, as used in this specification and appended claims, refer to structures that can be uncoupled, detached, uninstalled, or removed from an adjoining structure with relative ease (i.e., non-destructively, and without a complicated or time-consuming process), and that can also be readily reinstalled, reattached, or coupled to the previously adjoining structure.

The terms “partial cylinder” and “partially cylindrical,” as used in this specification and appended claims, refers to a structure having the shape of a cylinder with a portion of the cylinder along the cylinder longitudinal axis being absent. A semi-cylinder, which is ½ of a cylinder divided lengthwise, is an example of a partial-cylinder.

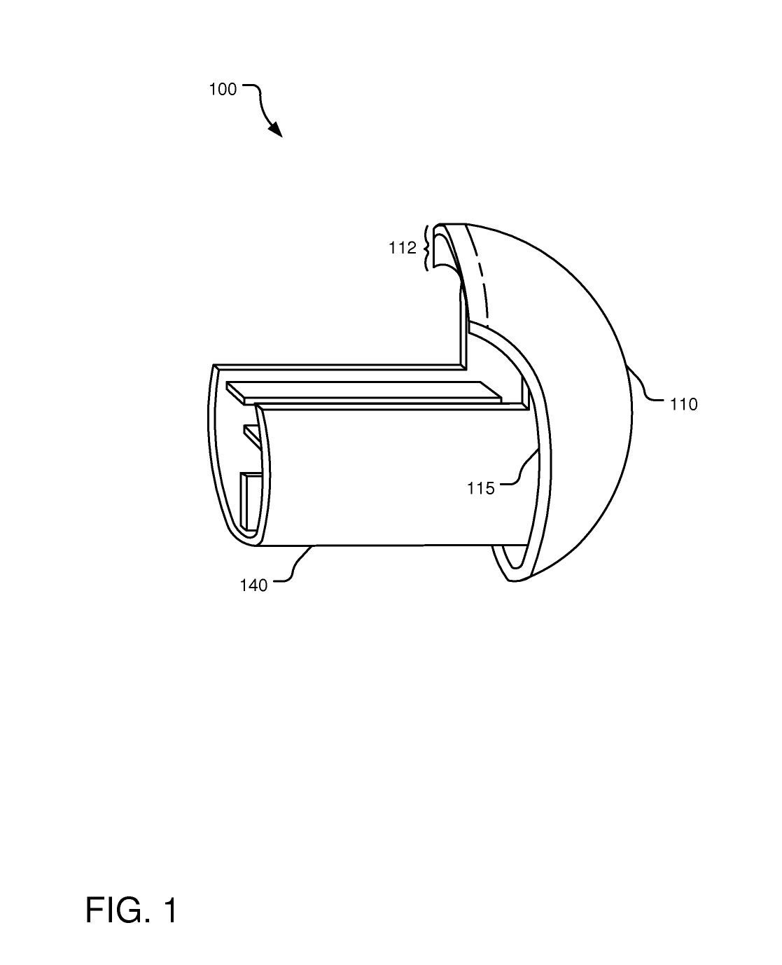

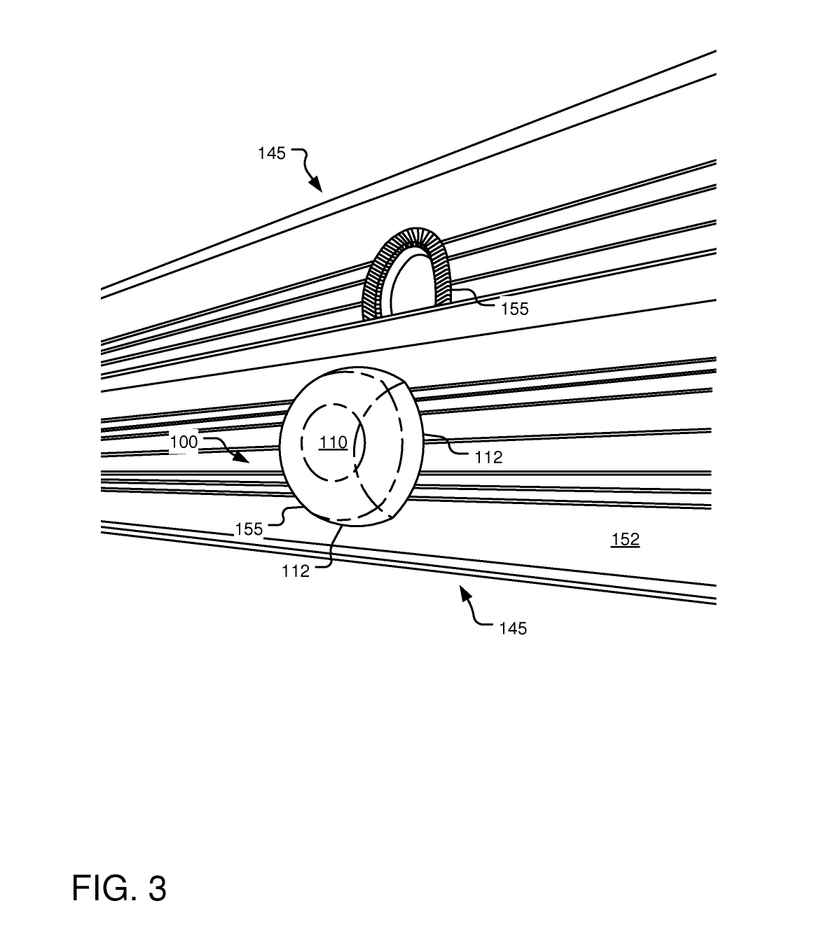

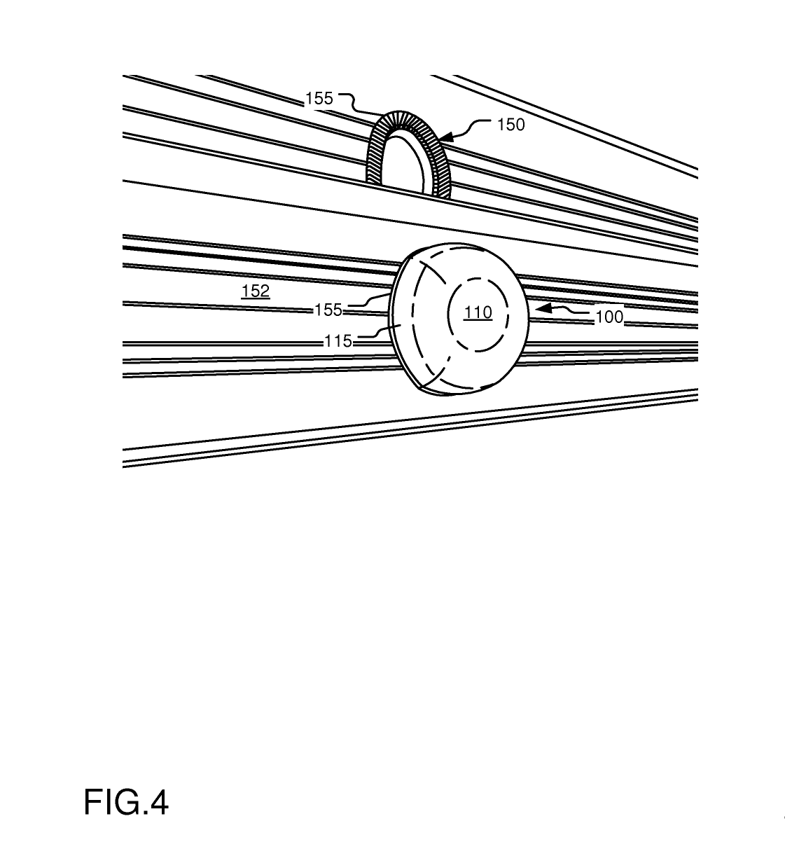

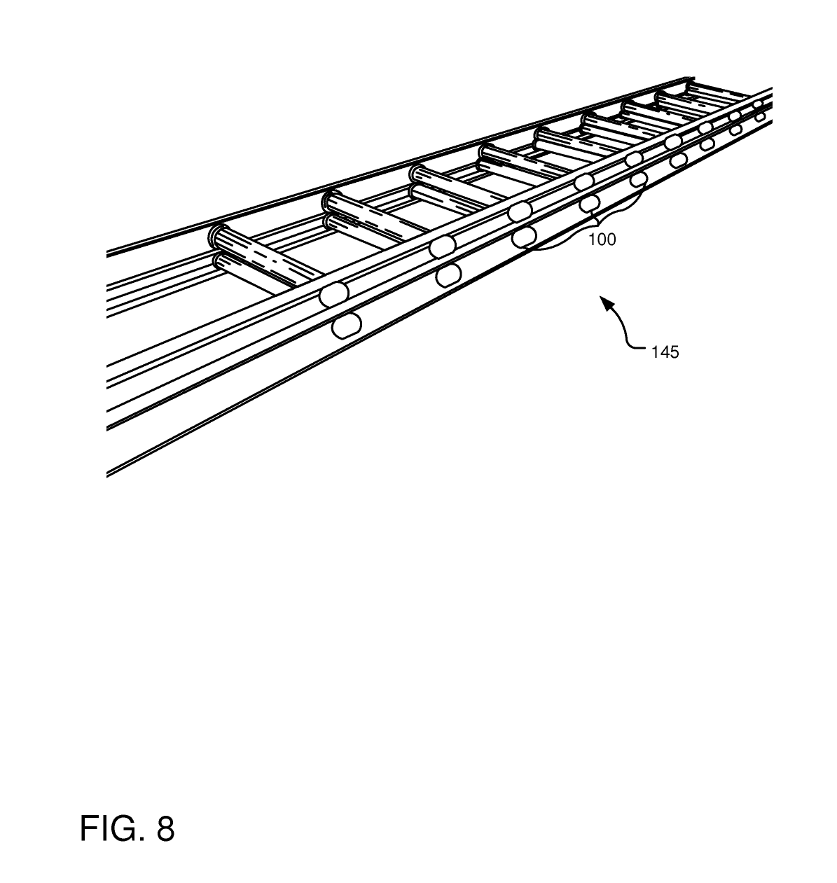

A first embodiment ladder rung plug 100 is illustrated in FIG. 1-8. The first embodiment ladder rung plug comprises a cap portion 110 and an insert portion 140. The cap portion 110 may be outwardly convex (shown in FIG. 1), and includes a tab section 112 and a recessed section 115. The insert portion 140 may be inserted into a ladder rung interior through a ladder rung opening, and the cap portion 110 may remain outside the ladder rung interior. The recessed section 115 is configured to install relatively flush with a ladder rung opening perimeter 155, and the tab section 112 is configured to extend substantially beyond the ladder rung opening perimeter 155 (seen in FIGS. 3-4 and 6-7), where the ladder rung plug 100 is installed in a ladder rung 151.

As seen in FIG. 5-7, the tab section 112 extending out beyond the perimeter 155 of a ladder rung opening 150 enables a user to insert a claw 172 of a claw hammer 170 between the tab section 112 and a ladder rail 152. Conversely, the recessed section 115 fits closely against the opening perimeter 155, which makes it difficult to insert a hammer claw 172 or other pry device between the recessed section 115 and the ladder 145.

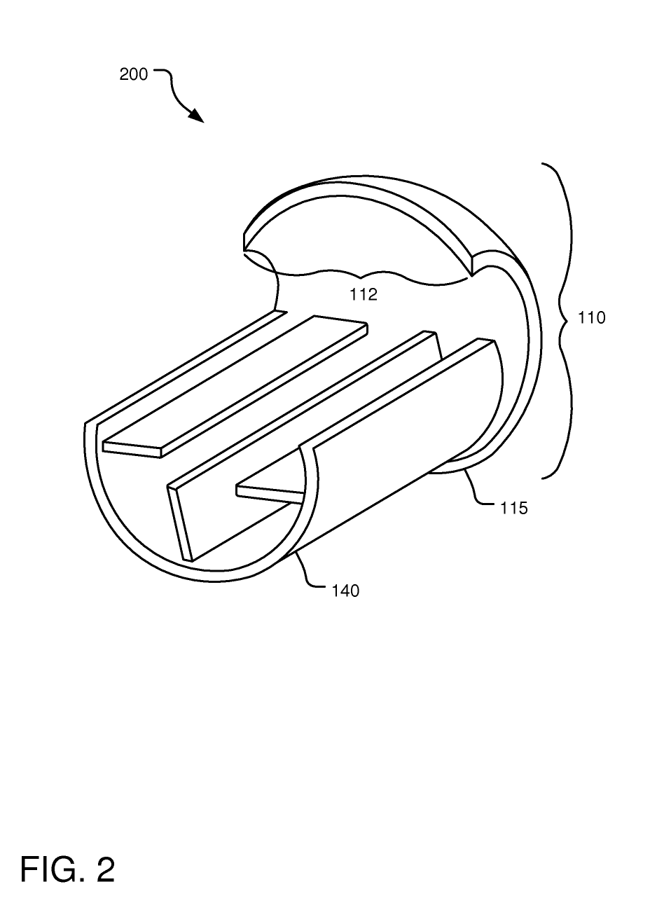

As shown in FIG. 1 and FIG. 2, the insert portion 140 of the first embodiment ladder rung plug 100 is partially cylindrical (approximately 180° of cylinder wall). Other embodiments include a partial cylinder that is between ¼ of a cylinder (approximately 90° of cylinder wall), and ¾ of a cylinder (approximately 270° of cylinder wall). Some embodiments include insert portions that are fully cylindrical, having 360° of cylinder wall. The partial cylinder wall of the first embodiment insert portion 140 is readily partially collapsed by a user squeezing the cylinder wall. The insert portion 140 can be readily inserted into a ladder rung 151 when partially collapsed. After insertion, the insert portion may expand to approach its original, uncollapsed state, and thus forms a tight friction fit inside the ladder rung 151. Without being partially collapsed, the insert portion may have a cylinder radius (to an outside of the cylinder wall) of approximately 0.75 inch. The uncollapsed cylinder radius may be 0.50 to 1.0 inch, and may be 0.65 to 0.85 inches.

The recessed section 115 of the cap portion 110 may project radially outwardly beyond the cylinder wall of the insert portion by about 0.125 to 0.250 inches. The tab section 112 of the cap portion 110 may project radially outwardly beyond the recessed section 115 by about 0.0625 to 0.375 inches. As seen in FIG. 1, the tab section 112 may also project longitudinally beyond the recessed section 115. In the first embodiment, the tab section 112 may, but not necessarily, reside adjacent to where a portion of the cylinder wall of the partially cylindrical insert section 140 is absent.

The first embodiment ladder rung plug may, but not necessarily, comprise a polyolefin. Typical polyolefins can include polyethylene, polypropylene, and high molecular weight polyethylene. In some embodiments, rung plugs consist essentially of a polyolefin such as polyethylene or polypropylene.

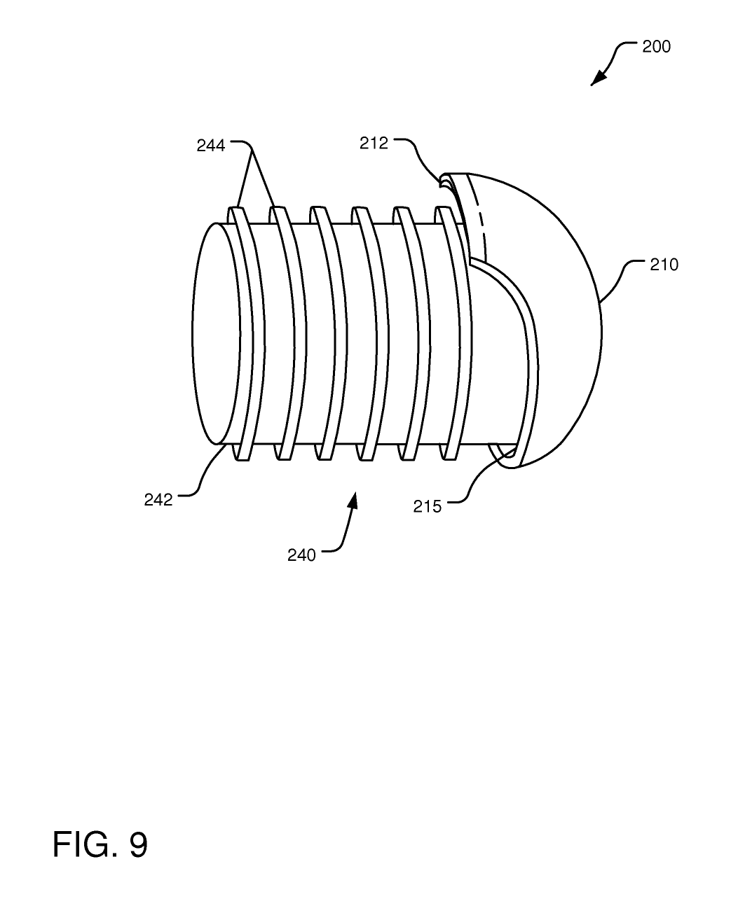

A second embodiment ladder rung plug 200 is illustrated in FIG. 9. The second embodiment ladder rung plug 200 comprises a cap portion 210 and an insert portion 240. The cap portion 210 includes a tab section 212 and a recessed section 215. The insert portion 240 of the second embodiment may include a cylinder wall 242 forming a full cylinder (360°), with one or more friction rings 244 encircling the cylinder wall 242 and coupled directly thereto. The friction rings 244 may deflect or deform as the insert portion 240 is inserted into a ladder rung, whereupon the rings 244 bind against a ladder rung to hold the rung plug 200 in place.

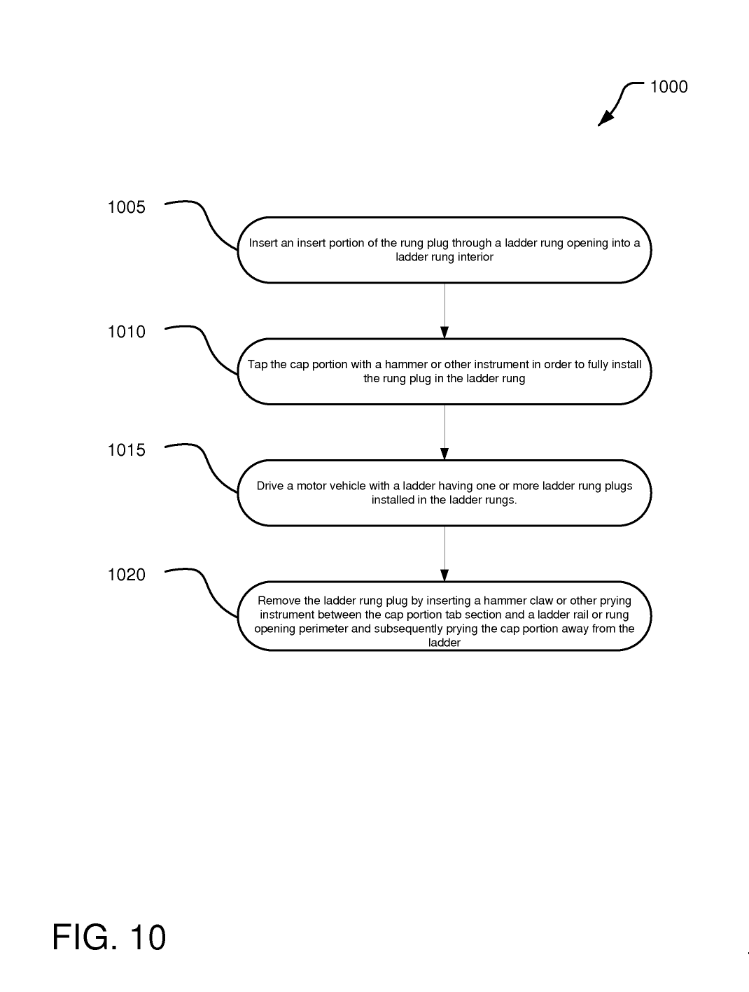

Referring now to FIG. 10, a first inserting operation 1005 includes inserting an insert portion of the rung plug through a ladder rung opening into a ladder rung interior. The first inserting operation 1005 can include squeezing cylinder walls of the insert portion in order to partially collapse the insert portion, which facilitates ready insertion into the ladder rung interior.

A second tapping operation 1010 includes tapping the cap portion with a hammer or other instrument in order to fully install the rung plug in the ladder rung. A user can sometimes strike the cap portion with his or her hand or first to fully install the rung plug. When fully installed, a recessed section of a cap portion may be snug against a ladder rung opening perimeter.

A third driving operation 1015 includes driving a motor vehicle with a having one or more ladder rung plugs installed in the ladder rungs.

A fourth removing operation 1025 includes removing the ladder rung plug by inserting a hammer claw or other prying instrument between a cap portion tab section and a ladder rail or rung opening perimeter, and subsequently prying the cap portion away from the ladder.

The various embodiments and variations thereof, illustrated in the accompanying figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

1. A ladder rung plug comprising:
a cap portion including a recessed section extending about a portion of a perimeter of the cap portion and a prying tab extending about a different portion of the perimeter of the cap portion; and
an insert portion projecting away from the cap portion, wherein:
the insert portion is partially cylindrical;
the cap portion is outwardly convex; and
the cap portion extends radially outwardly beyond the insert portion.

2. The ladder rung plug of claim 1, wherein the insert portion is resiliently collapsible.

3. The ladder rung plug of claim 1, wherein the cap portion and the insert portion each are comprised of a polyolefin.

4. The ladder rung plug of claim 1, wherein the cylindrical portion of the insert portion has a radius ranging from 0.5 to 1.0 inches.

5. The ladder rung plug of claim 1, further comprising:
one or more stiffening tabs extending from the insert portion and projecting inward toward a center of the insert portion.

6. The ladder rung plug of claim 1, wherein the insert portion is approximately 180 degrees of a cylinder.

7. The ladder rung plug of claim 1, wherein the insert portion is 90 to 270 degrees of a cylinder.

8. The ladder rung plug of claim 1, wherein the prying tab includes a scalloped outer edge.

9. A method of using a ladder rung plug comprising:
inserting an insert portion of the ladder rung plug into a ladder rung opening, wherein the insert portion is partially cylindrical; and
tapping the insert portion of the ladder rung plug into the ladder rung opening until a cap portion of the ladder rung plug rests against a perimeter of the ladder rung opening, wherein the cap portion is outwardly convex and extends radially outwardly beyond the insert portion, and wherein the cap portion includes a recessed section extending about a portion of a perimeter of the cap portion and a prying tab extending about a different portion of the perimeter of the cap portion.

10. The method of claim 9, wherein the prying tab includes a scalloped outer edge.

11. The method of claim 9, further comprising:
partially collapsing the insert portion of the ladder rung plug prior to performing the inserting operation.

12. The method of claim 9, wherein the ladder rung plug is friction fit within the ladder rung opening.

13. The method of claim 9, further comprising:
driving a motor vehicle with an externally attached ladder having the ladder rung plug inserted and tapped into the ladder rung opening.

14. The method of claim 9, further comprising:
inserting a prying instrument between the prying tab of the cap portion of the ladder rung plug and a ladder rail; and
prying the cap portion from the ladder rung.

15. A ladder rung plug comprising:
a cap portion including a recessed section extending about a portion of a perimeter of the cap portion and a prying tab extending about a different portion of the perimeter of the cap portion; and
an insert portion projecting away from the cap portion, wherein:
the insert portion includes one or more friction rings that encircle the insert portion;
the cap portion is outwardly convex; and
the cap portion extends radially outwardly beyond the insert portion.

16. The ladder rung plug of claim 15, wherein the insert portion is resiliently collapsible.

17. The ladder rung plug of claim 15, wherein the cap portion and the insert portion each are comprised of a polyolefin.

18. The ladder rung plug of claim 15 wherein the insert portion is cylindrical with a radius ranging from 0.5 to 1.0 inches.

19. The ladder rung plug of claim 15, further comprising:
one or more stiffening tabs extending from the insert portion and projecting inward toward a center of the insert portion.

20. The ladder rung plug of claim 15, wherein the prying tab includes a scalloped outer edge.
